(19) United States
(12) Patent Application Publication
(10) Pub. No.: US 2001/0023488 A1
(43) Pub. Date: Sep. 20, 2001

(54) Supply voltage booster for electronic modules

(76) Inventors: Volker Breunig, Ditzingen (DE); Andre Owerfeldt, Markgroeningen (DE); Matt Fenwick, Victoria (AU); Peter Scarlata, Gerlingen (DE); Simon Paul Casey, Victoria (AU); Gregory James Robinson, Victoria (AU)

Correspondence Address: KENYON & KENYON, One Broadway, New York, NY, 10004, US

(21) Appl. No.: 09/789,092

(22) Filed: Feb. 20, 2001

(30) Foreign Application Priority Data
Feb. 17, 2000 (AU) 17559/00

(51) Int. Cl. G06F 1/26; G06F 1/28; G06F 1/30

(52) U.S. Cl. 713/300

(57) ABSTRACT

An electronic control system includes a microprocessor and a boost circuit to boost a supply voltage to the microprocessor. The microprocessor generates a boost control signal to control the boost circuit.

### FIELD OF THE INVENTION

The present invention relates to a supply voltage booster for an electronic module. More particularly, the present invention relates to a booster circuit for maintaining an operating voltage of the electronic module during a period of low voltage supply.

### BACKGROUND INFORMATION

In automotive applications, there are certain times when a microprocessor of a body computer may not receive the minimum voltage supply level for normal operation, for example during cranking pulses. As it is important for the microprocessor to remain functional at these times, there have been attempts to overcome this problem, the most common of which is to provide a storage capacitor which supplies the requisite voltage potential in the absence of the normal supply potential. Unfortunately, the storage capacitor generally cannot sustain the voltage level for the required period of time. It is desired to provide a system which can alleviate this difficulty and which meets the tight cost constraints associated with vehicle components, or at least provide a system which constitutes a useful alternative.

### SUMMARY OF THE INVENTION

The present invention provides an electronic control system that includes a microprocessor and a boost circuit to boost a supply voltage to the microprocessor. The microprocessor generates a boost control signal to control the boost circuit.

Preferably, the boost control signal is a pulse width modulation (PWM) signal. Preferably, the duty cycle of the PWM signal is adjustable according to a predetermined relational mapping in response to a sensed level of the sampled supply voltage level. Preferably, the sensed level of the sampled supply voltage level is sensed by an analog-to-digital conversion circuit of the microprocessor.

Preferably, the system includes an isolation circuit interposed between the microprocessor and the boost circuit for providing a degree of electrical isolation of the boost circuit from the microprocessor in the event of microprocessor malfunction. Preferably, the isolation circuit includes a high-pass R-C filtering circuit with a cut-off frequency of about 500 Hertz.

Preferably, the boost circuit includes a field effect transistor (FET), the gate of which is responsive to the PWM signal from the microprocessor, an inductor and a capacitor element for providing the boost voltage when the FET is turned on by the PWM signal. Preferably, the PWM signal is modified by the microprocessor to prevent overshoot of the boost voltage. Preferably, the modification is effected by a feedback loop.

Advantageously, embodiments of the present invention provide a boost voltage to the microprocessor so as to enable the microprocessor to continue to operate even when it receives insufficient supply voltage. Further, the present invention advantageously allows the microprocessor to perform backup tasks when it senses that the battery is running low. For example, the microprocessor may cause an alarm signal to be transmitted or may save important information to non-volatile memory prior to the battery going flat.

### BRIEF DESCRIPTION OF THE DRAWINGS

FIG. 1a shows an electronic control system using a conventional isolation and protection circuit

FIG. 1b shows the conventional isolation and protection circuit of FIG. 1a in greater detail.

FIG. 2a is a first illustration of an electronic control system according to an embodiment of the present invention including a voltage boost subsystem.

FIG. 2b is a second illustration of an electronic control system according to an embodiment of the present invention including a voltage boost subsystem.

FIG. 3 shows a representative plot of the supply voltage to the microprocessor during an ignition period of the vehicle.

FIG. 4 shows an exemplary curve of the desired PWM duty cycle against the sampled supply voltage.

FIG. 5 is a flow chart illustrating a voltage boost procedure according to an embodiment of the present invention.

FIG. 6 shows an alternative circuit for use in the electronic control system shown in FIGS. 2a and 2b.

### DETAILED DESCRIPTION

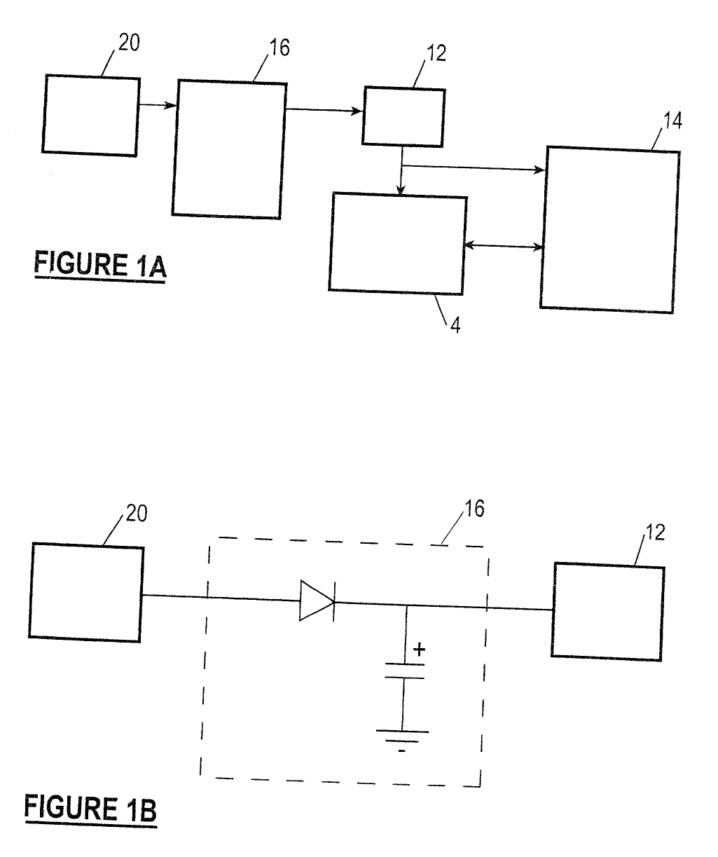

With reference to FIGS. 1a and 1b, a conventional electronic control system of a vehicle, such as an automobile, includes a microprocessor 4 which receives a supply voltage from the input voltage supply 20 via an isolation and protection subcircuit 16 and a voltage regulator 12. The microprocessor 4 interfaces with peripheral components 14 which also receive a supply voltage through the voltage regulator 12. The isolation and protection subcircuit 16 includes a diode and capacitor as shown in FIG. 1b.

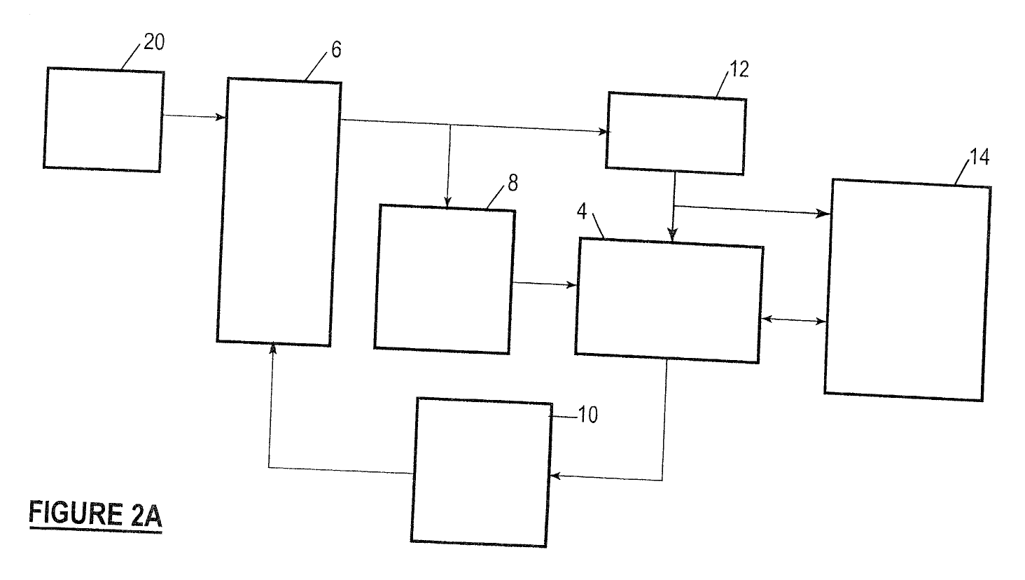

Referring now to FIG. 2a, the preferred embodiment of the present invention replaces the isolation and protection subcircuit 16 of the conventional vehicle system with a boost subsystem 6, a voltage sampling subsystem 8 and a boost subsystem isolation circuit 10 arranged so as to allow the microprocessor 4 to exercise feedback control over the boost subsystem 6. The boost subsystem 6 allows for a boost voltage to be supplied to the microprocessor 4 in the event that the input voltage supply 20 produces an insufficient supply level to maintain the microprocessor in the on state.

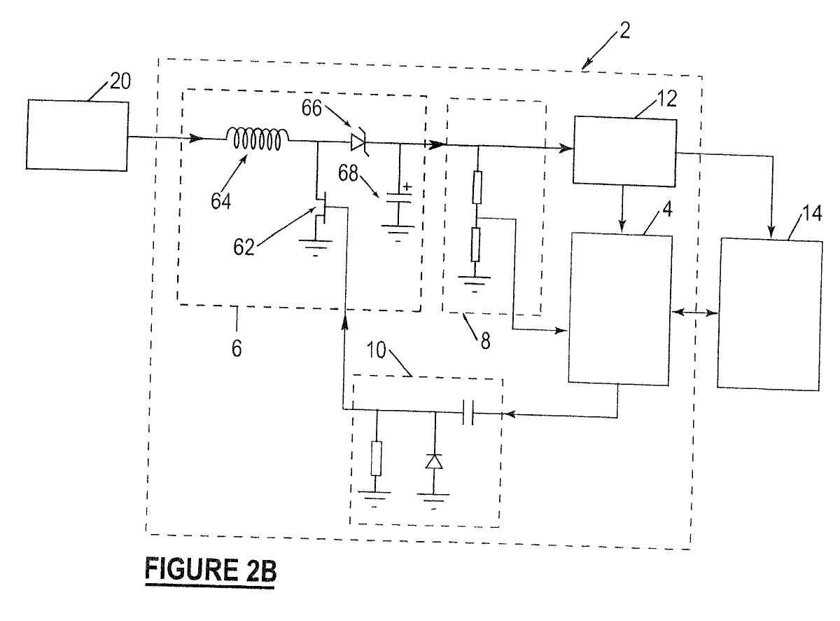

For example, if the input supply voltage decreases to a level of 3 volts, as is possible during the ignition period when the cranking pulses are supplied to the starter motor of a vehicle, the microprocessor 4 senses the low voltage level through the voltage sampling subsystem 8 and sends a boost signal to the boost subsystem 6 to increase the supply voltage to the microprocessor 4. FIG. 3 shows a representative plot of the supply voltage to the microprocessor during the ignition period of the vehicle when no boost voltage is employed.

An example of a microprocessor which would be suitable is a Motorola chip having a PWM output and an analog-to-digital input. Motorola chips such as the MC68HC908, MC68HC08 or MC68HC12 ranges would be suitable. Generally, such a microprocessor would not be able to run on a voltage supply of only 3 volts and a boost voltage would therefore be required in order to maintain the microprocessor in an operational state.

As shown in FIG. 2b, the boost subsystem 6 includes a field effect transistor (FET) 62, the gate of which receives a control input from the microprocessor 4 via the boost subsystem isolation circuit 10. The boost subsystem 6 also includes an inductor 64, Schottky diode 66 and capacitor 68. When the supply voltage to the microprocessor 4 is sufficient, the FET 62 remains off. When the microprocessor 4 senses, via the voltage sampling subsystem 8, that the supply voltage has fallen below the required level (which will depend on the microprocessor chip used in the specific application), the microprocessor 4 sends a PWM signal to periodically turn on the FET 62, thereby storing energy in the inductor 64 when the PWM signal is high. When the PWM signal is low, the stored energy in the inductor 64 charges the capacitor 68 via the Schottky diode 66. This boosts the charge in the capacitor 68, hence boosting the voltage supply to the voltage regulator 12. The Schottky diode 66 isolates the capacitor 68 from the FET 62 when the PWM signal is high.

The voltage sampling subsystem 8 is a simple voltage divider circuit including two resistors, and the output of the subsystem 8 is fed into an analog-to-digital conversion input circuit of the microprocessor 4. The microprocessor 4 preferably operates at a frequency in excess of 20 kHz and the sampling rate of the voltage sampling subsystem 8 should be synchronised appropriately to provide an accurate instantaneous indication of the voltage input to the voltage regulator 12.

In the event that the microprocessor 4 should malfunction and the output to the boost subsystem 6 should fail high, the boost subsystem isolation circuit 10 would act as an RC filter to attenuate signals below a certain threshold, for example 500 hertz, and thereby protect the boost subsystem 6. In this way, the boost subsystem isolation circuit 10 acts as a high pass filter to block a fail high DC signal from the microprocessor 4.

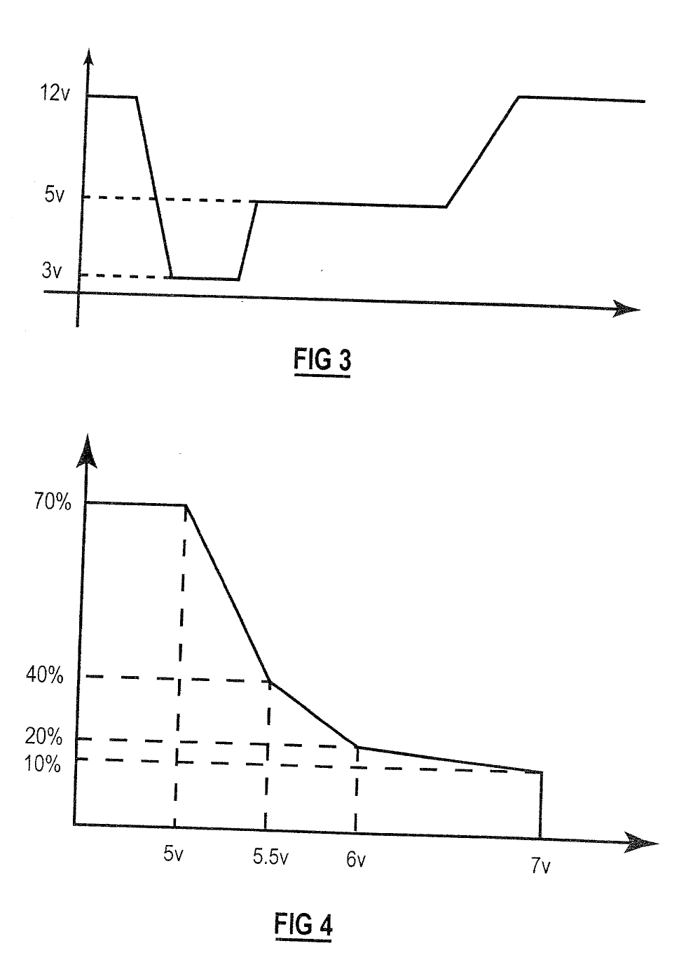

In the preferred embodiment, the microprocessor 4 outputs a pulse width modulation (PWM) signal to the boost subsystem 6 to periodically turn on and off the FET 62 according to a predetermined PWM duty cycle so as to boost the charge in the capacitor 68 while providing a higher averaged voltage supply to the voltage regulator 12. The PWM signal may be adaptively controlled by the microprocessor 4 so as to modify the duty cycle in response to the sensed voltage supply from the voltage sampling subsystem 8. FIG. 4 shows a representative curve of the desired PWM duty cycle corresponding to the input supply voltage at the voltage regulator 12. For example, if the input voltage supply level from the input voltage supply 20 continues to decrease over a particular period of time, the duty cycle of the PWM signal may be increased from approximately 10% to 70%. Further, in order to prevent overshoot of the voltage supply to the voltage regulator 12 during the ON cycle of the PWM signal (i.e., when the FET 62 is turned on), the increase in PWM duty cycle is controlled by a closed-loop feedback function within the microprocessor 4. For example, when the microprocessor 4 receives a sensed voltage level from the voltage sampling subsystem 8, this is applied to the desired PWM curve (as shown in FIG. 4) to give a desired PWM duty cycle level. The new PWM duty cycle level is then calculated as (for example):

New PWM duty cycle=(0.1×the desired PWM duty cycle)+(0.9×the previous PWM duty cycle level)

The proportion of feed back control is merely an example and it should be noted that varying proportions of feedback control may be appropriate.

Alternatively, the PWM duty cycle may be fixed, for example at 70%, and the microprocessor 4 merely turns on and off the PWM control to the booster subsystem 8 without exercising the adaptive feedback control described above. As a further, less preferable, alternative, the microprocessor 4 may output a PWM signal of fixed duty cycle which remains on while the input voltage supply level is below the required supply level threshold.

A further feature of the preferred embodiment of the present invention is that the boost subsystem 6 may optionally be enabled only for the approximate duration of the ignition sequence of the vehicle (i.e., during the period of reduced input voltage supply level to the microprocessor 4 corresponding to the cranking pulses). Once the microprocessor 4 receives the appropriate input from a peripheral component 14 to indicate that the cranking pulses are about to occur, the microprocessor 4 may enable the input signal to the boost subsystem 6. Advantageously, this may provide a power saving feature by saving microprocessor resources and allowing the PWM output from the microprocessor 4 to be disabled.

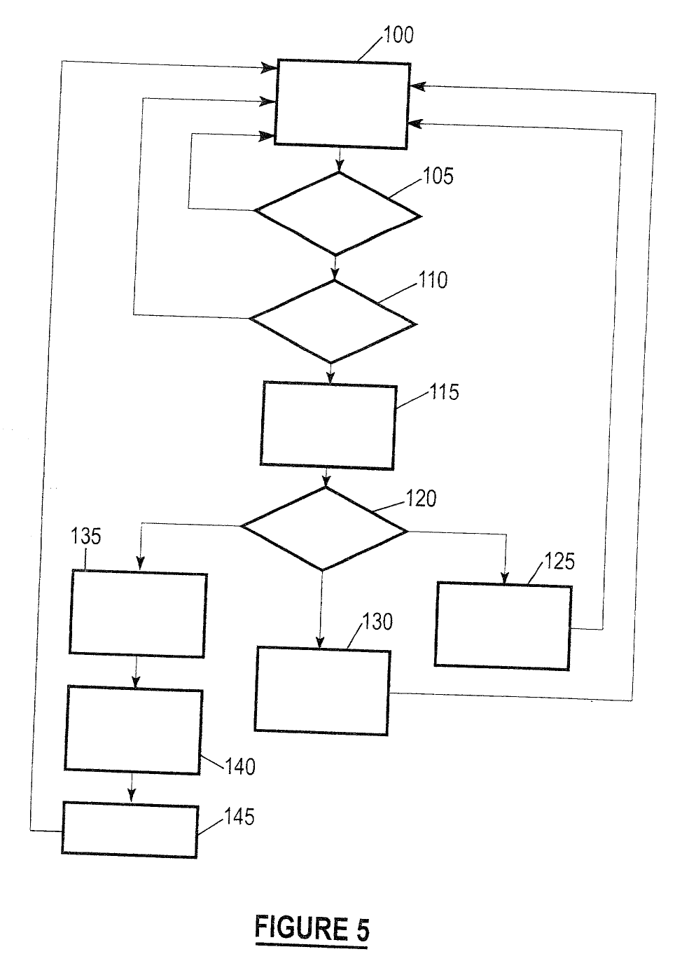

Referring now to FIG. 5, the microprocessor 4 may follow a main system program 100 in implementing the appropriate boost control of the supply voltage. At step 105, if it is time to check the input supply voltage level, the microprocessor 4 checks at step 110 whether there is any reason not to enable the boost subsystem (for example, if the cranking cycle is not activated). If the microprocessor 4 enables the boost subsystem 6 at step 110, the regulator input voltage is sampled at step 115. The analog-to-digital converter input of the microprocessor 4 converts the sampled input voltage to an 8-bit binary value and the microprocessor 4 makes a comparison at step 120 to determine what PWM duty cycle is appropriate for controlling the boost subsystem 6. If in fact the input voltage level is adequate, at step 125 the PWM signal is turned off so as not to unnecessarily boost the supply to the voltage regulator 12, and the microprocessor 4 returns to the main system program (step 100) to continue to monitor the input voltage supply level. If the sampled input voltage to the voltage regulator 12 is at a critically low level, at step 130 the maximum PWM boost signal is supplied to the boost subsystem 6 from the microprocessor 4. If the input voltage to the voltage regulator 12 is at a low level, but not a critically low level, the appropriate PWM, duty cycle is calculated at step 135 and, if it is desired to prevent overshoot of the boost voltage, a new PWM duty cycle level is calculated at step 140 in the adaptive closed-loop fashion as described above. If overshoot control is not enabled, then step 145 follows immediately from step 135. At step 145, the appropriate PWM boost signal is supplied to the boost subsystem 6. The procedure shown in FIG. 5 is an incremental procedure and should be followed for each sampled voltage read by the analog-to digital conversion circuit of the microprocessor 4 in order to maintain the boost voltage at the required level over the required period.

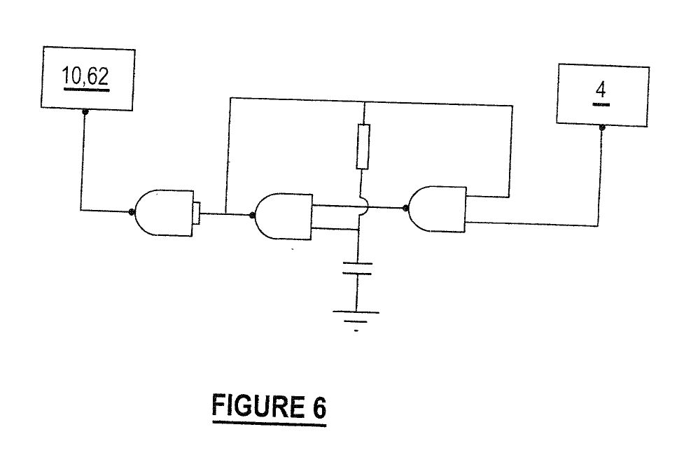

In an alternative embodiment of the present invention, an oscillator circuit may be interposed between the boost subsystem isolation circuit 10 and the microprocessor 4 (or may replace the boost subsystem isolation circuit 10) as shown in FIG. 6. The oscillator operates solely on an ON signal from the microprocessor and does not require a specific PWM output. The oscillator circuit is a known circuit using Schmitt trigger NAND gates and an R-C circuit (for providing the feedback delay) and simply serves to provide an oscillating ON/OFF signal to the FET 62 at a frequency determined by the time constant of the R-C circuit. In this case, the R-C circuit is set to provide an output of 30 kHz to the FET 62. This frequency level may be modified if desired by changing the time constant of the R-C circuit.

It will be understood by persons skilled in the art that alterations and modifications may be made to some features of the described embodiments of the present invention without departing from the spirit and scope of the present invention.

What is claimed is:

1. An electronic control system, comprising:
a microprocessor; and
a boost circuit to boost a supply voltage to the microprocessor, wherein:
the microprocessor generates a boost control signal to control the boost circuit.

2. The system of claim 1, wherein:
the microprocessor receives a sample signal representative of the supply voltage and adjusts the boost control signal in response thereto.

3. The system of claim 2, wherein:
the sample signal represents a sampled level of the supply voltage.

4. The system of claim 3, wherein:
the boost control signal is a pulse width modulation signal.

5. The system of claim 4, wherein:
a duty cycle of the pulse width modulation signal is adjusted in response to the sampled level periodically.

6. The system of claim 5, wherein:
the pulse width modulation signal is adjusted according to a predetermined pulse width modulation duty cycle and a sampled level curve.

7. The system of claim 6, wherein:
the pulse width modulation signal is modified by the microprocessor to prevent an overshoot of the supply voltage.

8. The system of claim 7, wherein:
the modification is effected by a feedback loop which adjusts the pulse width modulation duty cycle for one period based on the pulse width modulation duty cycle for a previous period.

9. The system of claim 4, wherein:
a duty cycle of the pulse width modulation signal is fixed.

10. The system of claim 9, wherein:
the pulse width modulation signal is one of turned on and turned off in response to the sampled level.

11. The system of claim 9, wherein:
the pulse width modulation signal remains on when the boost circuit is enabled.

12. The system of claim 1, further comprising:
an isolation circuit interposed between the microprocessor and the boost circuit and for providing a degree of electrical isolation of the boost circuit from the microprocessor.

13. The system of claim 12, wherein:
the isolation circuit includes a high pass filtering circuit with a cut-off frequency of about 500 Hertz.

14. The system of claim 4, further comprising:
a voltage sampling circuit for providing the sample signal to the microprocessor.

15. The system of claim 4, wherein:
the boost circuit includes:
an inductor connected to a switch that is switched by the pulse width modulation signal, and
a capacitor element connected across the switch and in series with the inductor to store a charge to boost the supply voltage.

16. The system of claim 4, further comprising:
a voltage regulator that receives and regulates the supply voltage for the microprocessor.

17. The system of claim 1, further comprising:
an oscillator circuit through which the microprocessor provides the boost control signal wherein:
the oscillator circuit is arranged intermediate the booster circuit and the microprocessor, and
the oscillator circuit modulates a boosting of the supply voltage to the microprocessor.

18. The system of claim 1, wherein:
the boost control signal has a fixed frequency.

19. The system of claim 18, wherein:
the fixed frequency is above about 30 kHz.

20. The system of claim 1, wherein:
the boost circuit is enabled by the microprocessor substantially for a duration of a start signal generated by a vehicle including the system.

21. The system of claim 2, wherein:
the microprocessor generates the boost control signal when a sense pin of the microprocessor is triggered by the sample signal.

22. The system of claim 21, wherein:
the boost circuit includes an oscillator controlled by the boost control signal.
